(19) United States
(12) Patent Application Publication
(10) Pub. No.: US 2004/0092655 A1
(43) Pub. Date: May 13, 2004

(54) Mouldable silicone gel compositions

(76) Inventor: Takayoshi Otomo, Chiba City (JP)

Correspondence Address: MCKELLAR STEVENS & HILL PLLC, POSEYVILLE PROFESSIONAL COMPLEX, 784 SOUTH POSEYVILLE ROAD, MIDLAND, MI, 48640, US

(21) Appl. No.: 10/682,445

(22) Filed: Oct. 9, 2003

Related U.S. Application Data
(63) Continuation-in-part of application No. 10/114,374, filed on Apr. 1, 2002, now abandoned.

(30) Foreign Application Priority Data
Apr. 2, 2001 (JP) 2001-102980

(51) Int. Cl. C08L 83/00

(52) U.S. Cl. 524/588

(57) ABSTRACT

A mouldable silicone gel composition that forms a low compression set silicone gel that exhibits an excellent mould releasability comprising: A, 100 parts by weight of an organopolysiloxane having at least two alkenyl groups in each molecule, B, an organopolysiloxane having at least two silicon-bonded hydrogen atoms in each molecule, in an amount such that the molar ratio of silicon bonded hydrogen atoms in component B to alkenyl groups in component A is from 0.5:1 to 10: 1, C 100 to 500 parts by weight of organopolysiloxane whose molecule is free of both alkenyl groups and silicon bonded hydrogen, and D a platinum group catalyst, in an amount sufficient to effect the cure of the composition.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF INVENTION

This invention relates to a mouldable silicone gel composition for use in moulding operations utilizing a mould. More particularly, this invention relates to a mouldable silicone gel composition that forms a low compression set silicone gel that exhibits an excellent mould releasability.

### BACKGROUND OF THE INVENTION

It is to be understood that very “soft”, mouldable silicone rubbers, which typically have high compression sets, may be referred to as silicone gels and the present application will henceforth refer to such rubbers as silicone gels. Silicone gel compositions are used as, for example, sealants, filling and packing agents and protective agents because the silicone gels afforded by their cure exhibit excellent vibration absorbing capacity, electrical properties, heat resistance, and water resistance.

Silicone gels are, however, tacky and weak. When a silicone gel composition is subjected to moulding in a mould, the resulting silicone gel will stick strongly to the mould and will rupture when forcibly peeled there from. In addition, silicone gels exhibit a large compression set and have trouble recovering their shape when an applied compression stress is released after long term application.

JP 06-166822 describes an ozone resistant silicone gel composition used as a filling or sealing material for electrical devices comprising 100 parts by weight of an organopolysiloxane having at least two alkenyl groups in each molecule, an organopolysiloxane having at least two silicon-bonded hydrogen atoms in each molecule, in an amount such that the molar ratio of silicon bonded hydrogen atoms to alkenyl groups is from 0.8:1 to 1.2:1, 0.01 to 30 parts by weight of an organopolysiloxane which is free of both alkenyl groups and silicon bonded hydrogen and contains phenyl groups in an amount of from 0.5 to 40 mole % of the total number of organic groups bonded to silicon per molecule, and a platinum group catalyst, in an amount sufficient to effect the cure of the composition.

JP 05-005064, and its equivalent, CA 2071788, describe a silicone rubber composition for a durable gasket comprising 100 parts by weight of an organopolysiloxane having two or more Si-bonded alkenyl groups per molecule, an organohydrogen polysiloxane containing two or more Si-bonded H atoms per molecule in an amount to give the molar ratio of Si-bonded H atom to Si-bonded alkenyl group of from 0.5:1 to 20:1, a platinum-based catalyst and 1-80 parts by weight of an organopolysiloxane oil which is free of alkenyl groups and free of silicon bonded hydrogen and/or a hydrocarbon oil free from alkenyl groups.

The present inventor achieved this invention as a result of extensive investigations directed to solving the problems described above. In more specific terms, the object of this invention is to provide a mouldable silicone gel composition that may form a low compression set silicone gel that exhibits excellent mould releasability.

### DETAILED DESCRIPTION OF THE INVENTION

In accordance with the present invention there is provided a mouldable silicone gel composition comprising the following components:

A. 100 parts by weight of an organopolysiloxane having at least two alkenyl groups in each molecule,

B. an organopolysiloxane having at least two silicon-bonded hydrogen atoms in each molecule, in an amount such that the molar ratio of silicon bonded hydrogen atoms in component B to alkenyl groups in component A is from 0.5:1 to 10:1,

C. greater than 200 parts to 500 parts by weight of organopolysiloxane which is free of alkenyl groups and free of silicon bonded hydrogen, and

D. a platinum group catalyst, in an amount sufficient to effect the cure of the composition.

Component A is an organopolysiloxane that contains at least two alkenyl groups in each molecule. Each alkenyl group may be the same or different and may, for example, be a vinyl, allyl, butenyl, pentenyl, or hexenyl group. The non-alkenyl silicon-bonded organic groups in component A may be the same or different and are exemplified by alkyl groups such as methyl, ethyl, and propyl; aryl groups such as phenyl and tolyl; and halogenated alkyl groups such as 3,3,3-trifluoropropyl. Preferably, the non-alkenyl groups are alkyl groups most particularly methyl groups. The molecular structure of component A may be a straight chain, a partially branched straight chain, a branched chain, a network, or dendritic. Preferably the viscosity of component A at 25° C. is in the range of from 100 to 1,000,000 mPa.s, more preferably from 1,000 to 100,000 mPa.s and most preferably from 1,000 to 50,000 mPa.s.

Component A is preferably selected from at least one of the group consisting of:

i. dimethylalkenylsiloxy-endblocked dimethylpolysiloxanes;

ii. dimethylalkenylsiloxy-endblocked dimethylsiloxane-methylalkenylsiloxane copolymers;

iii. trimethylsiloxy-endblocked dimethylsiloxane-methylalkenylsiloxane copolymers;

iv. organopolysiloxanes comprising the (CH₃)₃SiO_{1/2}, (CH₃)₂(alkenyl)SiO_{1/2}, and SiO_{4/2} siloxane units;

v. organopolysiloxanes as defined in i to iv above wherein a proportion of the methyl groups are replaced by one or more ethyl, propyl, phenyl tolyl and/or 3,3,3-trifluoropropyl groups. wherein the alkenyl groups are vinyl, allyl, propenyl, butenyl, pentenyl, or hexenyl groups.

Component B functions as a cross-linking agent and is an organopolysiloxane having at least two silicon-bonded hydrogen atoms in each molecule. The silicon-bonded organic groups in component B may be exemplified by alkyl groups such as methyl, ethyl, and propyl; aryl groups such as phenyl and tolyl; and halogenated alkyl groups such as 3,3,3-trifluoropropyl. Preferably, the silicon-bonded organic groups are alkyl groups most preferably methyl groups. The molecular structure of component B may be a straight chain, a partially branched straight chain, a branched chain, a network, or dendritic. Preferably the viscosity of component B at 25° C. is in the range of from 1 to 1,000,000 mPa.s, more preferably from 1 to 500 mPa.s and most preferably from 1 to 100 mPa.s.

Component B is preferably selected from at least one of the group consisting of:

i dimethylhydrogensiloxy-endblocked dimethylpolysiloxanes;

ii. trimethylsiloxy-endblocked methylhydrogenpolysiloxanes;

iii. trimethylsiloxy-endblocked dimethylsiloxane-methylhydrogensiloxane copolymers;

iv. cyclic methylhydrogenpolysiloxanes;

v. organopolysiloxanes comprising the (CH₃)₂HSiO_{1/2} and SiO_{4/2} siloxane units;

vi. organopolysiloxanes as defined by i to v above wherein a proportion of the methyl groups are replaced by one or more ethyl, propyl, phenyl tolyl and/or 3,3,3-trifluoropropyl groups.

Component B is present in the composition in accordance with the present invention in an amount such that the molar ratio of silicon bonded hydrogen atoms in component B to alkenyl groups in component A is from 0.5:1 to 10:1, preferably the ratio is from 1:1 to 5:1. The cure of the silicone gel composition becomes increasingly unacceptable as the amount of component B in the composition declines below the lower limit of the aforementioned range. The silicone gel will adhere strongly to the mould when the upper limit on the aforementioned range is exceeded, which results in a decline in the mould releasability.

Component C is an organopolysiloxane which functions to improve the mould releasability of the silicone gel afforded by the cure of the composition under consideration and to impart a good flexibility to the silicone gel while keeping its compression set low. Component C is distinguished from components A and B by the fact that it is free of both alkenyl groups and silicon bonded hydrogen. The silicon-bonded organic groups in component C may be exemplified by alkyl groups such as methyl, ethyl, and propyl; aryl groups such as phenyl and tolyl and halogenated alkyl groups such as 3,3,3-trifluoropropyl. Preferably the silicon-bonded organic groups are alkyl groups and most preferably are methyl groups. The molecular structure of component C may be a straight chain, a partially branched straight chain, a branched chain, or cyclic. Preferably the viscosity of component C at 25° C. is the range of from 50 to 50,000 mPa.s, more preferably from 50 to 10,000 mPa.s and most preferably from 50 to 5,000 mPa.s. Evaporation of component C from the silicone gel product will occur with increasing ease when component C has a viscosity below the lower limit on the aforementioned range, while adhesion of the silicone gel product to the mould becomes increasingly pronounced when the viscosity of component C exceeds the upper limit on the aforementioned range.

Examples of Component C include but are not restricted to:

trimethylsiloxy-endblocked dimethylpolysiloxanes, trimethylsiloxy-endblocked dimethylsiloxane-methylphenylsiloxane copolymers, trimethylsiloxy-endblocked dimethylsiloxane-diphenylsiloxane copolymers, dimethylphenylsiloxy-endblocked dimethylpolysiloxanes, dimethylphenylsiloxy-endblocked dimethylsiloxane-methylphenylsiloxane copolymers, or a mixture of any two or more of the above

Component C is provided in the composition in accordance with the invention in a range of from greater than 200 parts to 500 parts by weight per 100 parts by weight of component A and more preferably from 100 to 300 parts by weight per 100 parts by weight of component A. The mould releasability of the silicone gel product declines when component C content is below the lower limit on the aforementioned range, while the mechanical strength of the silicone gel product declines when the upper limit on the aforementioned range is exceeded.

Component D is a platinum group catalyst that accelerates the cure of the composition in accordance with the present invention. Component D may be exemplified by platinum catalysts, rhodium catalysts, and palladium catalysts; the platinum catalysts may be further exemplified by finely divided platinum, platinum black, chloroplatinic acid, alcohol solutions of chloroplatinic acid, olefin complexes of platinum, alkenylsiloxane complexes of platinum, and carbonyl complexes of platinum.

Component D is utilised in an amount sufficient to initiate curing of the composition in accordance with the present invention and is preferably present in an amount of from 0.1 to 500 parts by weight per 1,000,000 parts by weight of component A when expressed as the content of platinum metal in component D.

The composition in accordance with the present invention may also contain a finely divided silica filler, henceforth referred to as component E, in order to improve the mechanical strength of the silicone gel product. Component E may be exemplified by a treated or untreated reinforcing fillers such as fumed silica, precipitated silica, calcined silica, crushed quartz. The treated reinforcing fillers are obtained by treating the surface of the aforementioned finely divided silicas with an organosilicon compound such as, for example, organoalkoxysilane, organohalosilane, or organosilazane. The use of finely divided silica with a BET specific surface area of at least 50 m²/g as component E is particularly preferred for the purpose of obtaining a substantial improvement in the mechanical strength of the silicone gel product.

Component E may be present in the composition in accordance with the present invention in any appropriate amount but for the purpose of improving the mechanical strength of the silicone gel product component E is preferably present in an amount of from 1 to 100 parts by weight and more preferably from 1 to 50 parts by weight, per 100 parts by weight of component A.

The composition in accordance with the present invention may contain one or more further optional additives provided they do not impair said composition. These optional additives include, but are not restricted to, treated or untreated inorganic extending fillers such as fumed titanium oxide, carbon black, diatomaceous earth, iron oxide, aluminium oxide, aluminosilicate, and calcium carbonate; fillers, said treated fillers being obtained by treating their surface with an organosilicon compound such as, for example, an organoalkoxysilane, an organohalosilane, or an organosilazane; cure retardation agents for example alkyne alcohols such as 3-methyl-1-butyn-3-ol, 3,5-dimethyl-1-hexyn-3-ol, and 3-phenyl-1-butyn-3-ol; ene-yne compounds such as 3-methyl-3-penten-1-yne and 3,5-dimethyl-3-hexen-1-yne; tetramethyltetrahexenylcyclotetrasiloxane, and benzotriazole; compression set improvers such as copper phthalocyanine and copper phthalocyanine chloride; reinforcing agents; viscosity regulators; heat stabilizers; flame retardants; thermally conductive fillers; electrically conductive fillers; and adhesion promoters.

Any appropriate method may be utilised in preparing the composition in accordance with the present invention, for example, by intermixing components A, B, C and D together with any optional components. However, when the composition in accordance with the present invention contains component E, it is preferably prepared by intermixing components A, E and optionally a proportion of component C with heating to form a silicone gel base; and then adding components B, D and all or any remaining part of component C to the silicone gel base.

When other optional components are to be included in the composition, these may be intermixed during preparation of the silicone gel base, or, if the optional component might be altered or modified by mixing at an elevated temperature it is preferably added together with component B or D. In addition, an appropriate organosilicon compound such as an organoalkoxysilane, an organohalosilane, or an organosilazanes, may be added during the preparation of the silicone gel base by mixing and heating component A with component E in order to effect in-situ treatment of the surface of component E.

The curing of the composition in accordance with the present invention yields a low compression set silicone gel that exhibits an excellent mould releasability. While the hardness of the silicone gel is not critical, the gel preferably has an Asker C hardness in the range of from 0 to 30° and more preferably from 1 to 30°. The Asker C hardness may be measured using an Asker C hardness meter, which corresponds to the spring hardness tester specified in Japanese Industrial Standard Test Method (JIS) S 6050 (1994).

In a further embodiment of the present there is provided a moulded silicone gel comprising a cured composition as hereinbefore described.

### EXAMPLES

The mouldable silicone gel composition in accordance with the present invention will be exemplified in the following examples, in which all values of viscosity were measured at 25° C.

### Example 1

The following were blended:

100 parts by weight of trimethylsiloxy-endblocked dimethylsiloxane-methylvinylsiloxane copolymer having a viscosity of 10,000 mpa.s; 40 parts by weight of fumed silica with a BET specific surface area of 200 m²/g; 5 parts by weight of hexamethyldisilazane as treatment agent for the silica, and 2 parts by weight of water. The resulting blend was subsequently mixed and heated under reduced pressure to produce a fluid silicone gel base.

A mouldable silicone gel composition was then prepared by mixing the following: 140 parts by weight of the fluid silicone gel base described above; 230 parts by weight of trimethylsiloxy-endblocked dimethylpolysiloxane with a viscosity of 3,000 mPa.s, trimethylsiloxy-endblocked dimethylsiloxane-methylhydrogensiloxane copolymer with a viscosity of 10 mPa.s, in an amount such that there was 1.6 moles of silicon-bonded hydrogen per mole of vinyl groups in the dimethylsiloxane-methylvinylsiloxane copolymer present in the silicone gel base, a platinum-1,3-divinyltetramethyldisiloxane complex in an amount such that there was present 35 parts by weight of platinum metal per 1,000,000 parts by weight of the dimethylsiloxane-methylvinylsiloxane copolymer present in the silicone gel base, and 0.12 parts by weight of 3,5-dimethyl-1-hexyn-3-ol.

The mould releasability, Asker C hardness, and compression set of the resulting cured product were measured using the test methods described hereafter and the results thereof are reported in Table 1.

### Mould Releasability

The silicone gel composition was cast into a steel mould provided with a square cavity (depth=5 mm, length of 1 side=100 mm) and was press-cured for 10 minutes at 150° C. The ease with which the resulting silicone gel could be removed from the mould was then evaluated.

### Asker C Hardness

The hardness of the silicone gel after press-curing (primary vulcanisation) was measured using an Asker C hardness meter. The hardness of the silicone gel was also measured by the same method after a secondary vulcanisation consisting of heating for 4 hours at 200° C.

### Compression Set

he silicone gel composition was cured for 10 minutes at 150° C. in order to fabricate a test piece for measurement of the compression set in accordance with the method described in JIS K 6249. The test piece was then subjected to secondary vulcanisation for 4 hours at 200° C. This was followed by measurement of the compression set (compression for 70 hours at 150° C.) in accordance with the method specified in JIS K 6249.

### Comparative Example 1

A mouldable silicone gel composition was prepared by mixing the following:

140 parts by weight of fluid silicone gel base prepared as described in Example 1, 100 parts by weight of dimethylvinylsiloxy-endblocked dimethylpolysiloxane with a viscosity of 40,000 mPa.s, trimethylsiloxy-endblocked dimethylsiloxane-methylhydrogensiloxane copolymer with a viscosity of 10 mPa.s in an amount such that there was 0.5 moles of silicon-bonded hydrogen per mole of vinyl groups in the dimethylsiloxane-methylvinylsiloxane copolymer present in the silicone gel base, a platinum-1,3-divinyltetramethyldisiloxane complex in an amount such that there was present 10 parts by weight of platinum metal per 1,000,000 parts by weight of the dimethylsiloxane-methylvinylsiloxane copolymer present in the silicone gel base, and 0.1 parts by weight 3,5-dimethyl-1-hexyn-3-ol. The mould releasability, Asker C hardness, and compression set were measured as in Example 1 on silicone gels produced by the cure of this silicone gel composition. The results are reported in Table 1.

### Comparative Example 2

A mouldable silicone gel composition was prepared by mixing the following:

140 parts by weight of fluid silicone gel base prepared as described in Example 1, 70 parts by weight of trimethylsiloxy-endblocked dimethylpolysiloxane with a viscosity of 3,000 mPa.s, trimethylsiloxy-endblocked dimethylsiloxane-methylhydrogensiloxane copolymer with a viscosity of 10 mPa.s in an amount such that there was 0.9 moles of silicon-bonded hydrogen per mole of vinyl group in the dimethylsiloxane-methylvinylsiloxane copolymer present in the silicone gel base, a platinum-1,3-divinyltetramethyldisiloxane complex in an amount such that there was present 10 parts by weight of platinum metal per 1,000,000 parts by weight of the dimethylsiloxane-methylvinylsiloxane copolymer present in the silicone gel base, and 0.1 parts by weight 3,5-dimethyl-1-hexyn-3-ol. The mould releasability, Asker C hardness, and compression set were measured as in Example 1 on silicone gels produced by the cure of this silicone gel composition. The results are reported in Table 1.

TABLE 1

| | Example 1 | Comp. Ex. 1 | Comp. Ex. 2 |
|---|---|---|---|
| Asker C hardness | 5 | 5 | 5 |
| after primary vulcanisation | | | |
| after secondary | 6 | 7 | 7 |
| vulcanisation | | | |
| Mould releasability | no sticking to the | strong sticking to | strong sticking to |
| | mould, could be | the mould, the | the mould, the |
| | easily peeled out | silicone gel was | silicone gel was |
| | | torn | torn |
| compression set | 18% | 60% | 55% |

### Example 2

The following were blended:

100 parts by weight of dimethylvinylsiloxy-endblocked dimethylpolysiloxane with a viscosity of 10,000 mPa.s and 20 parts by weight of fumed silica with a BET specific surface area of 200 m²/g whose surface had already been treated with dimethyldichlorosilane. Blending was followed by mixing and heating under reduced pressure to produce a fluid silicone gel base.

A mouldable silicone gel composition was then prepared by mixing the following: 120 parts by weight of the fluid silicone gel base described above, 140 parts by weight of trimethylsiloxy-endblocked dimethylpolysiloxane with a viscosity of 100 mPa.s, a trimethylsiloxy-endblocked dimethylsiloxane-methylhydrogensiloxane copolymer with a viscosity of 5 mPa.s in an amount such that there was 1.4 moles of silicon-bonded hydrogen per mole of vinyl groups in the dimethylvinylsiloxy-endblocked dimethylpolysiloxane present in the silicone gel base, a platinum-1,3-divinyltetramethyldisiloxane complex in an amount such that there was present 35 parts by weight of platinum metal per 1,000,000 parts by weight of the dimethylsiloxane-methylvinylsiloxane copolymer present in the silicone gel base, and 0.12 parts by weight of 3,5-dimethyl-1-hexyn-3-ol, and 1 part by weight of finely divided copper phthalocyanine.

The mould releasability, Asker C hardness, and compression set were measured as described below on silicone gels produced by the cure of the aforementioned silicone gel composition. The results are reported in Table 2.

### Mould Releasability

The silicone gel composition was cast into a chromium-plated steel mould provided with a cylindrical cavity (diameter=2 mm, length=100 mm) and was press-cured for 10 minutes at 120° C. The ease with which the resulting silicone gel could be removed from the mould was then evaluated.

### Asker C Hardness

The hardness of the silicone gel after press-curing (primary vulcanisation) was measured using an Asker C hardness meter.

### Compression Set

The silicone gel composition was cured for 10 minutes at 120° C. in order to fabricate a test piece for measurement of the compression set in accordance with the method described in JIS K 6249. The compression set (compression for 70 hours at 150° C.) was then measured on this test piece in accordance with the method specified in JIS K 6249.

### Comparative Example 3

A mouldable silicone gel composition was prepared by mixing the following:

120 parts by weight of fluid silicone gel base prepared as described in Example 2, 100 parts by weight of dimethylvinylsiloxy-endblocked dimethylpolysiloxane with a viscosity of 10,000 mpa.s, trimethylsiloxy-endblocked dimethylsiloxane-methylhydrogensiloxane copolymer with a viscosity of 5 mPa.s in an amount such that there was 0.6 moles of silicon-bonded hydrogen per mole of vinyl groups in the dimethylvinylsiloxy-endblocked dimethylpolysiloxane present in the silicone gel base, a platinum-1,3-divinyltetramethyldisiloxane complex in an amount such that there was present 10 parts by weight of platinum metal per 1,000,000 parts by weight of the dimethylsiloxane-methylvinylsiloxane copolymer present in the silicone gel base, parts by weight of 3,5-dimethyl-1-hexyn-3-ol, and 1 part by weight of finely divided copper phthalocyanine. The mould releasability, Asker C hardness, and compression set were measured as in Example 2 on silicone gels produced by the cure of this silicone gel composition. The results are reported in Table 2.

### Comparative Example 4

A mouldable silicone gel composition was prepared by mixing the following:

120 parts by weight of fluid silicone gel base prepared as described in Example 2, 50 parts by weight of trimethylsiloxy-endblocked dimethylpolysiloxane with a viscosity of 100 mPa.s, trimethylsiloxy-endblocked dimethylsiloxane-methylhydrogensiloxane copolymer with a viscosity of 5 mPa.s in an amount such that there was 0.9 moles of silicon-bonded hydrogen per mole of vinyl groups in the dimethylvinylsiloxy-endblocked dimethylpolysiloxane present in the silicone gel base, a platinum-1,3-divinyltetramethyldisiloxane complex in an amount such that there was present 10 parts by weight of platinum metal per 1,000,000 parts by weight of the dimethylsiloxane-methylvinylsiloxane copolymer present in the silicone gel, 0.1 parts by weight of 3,5-dimethyl-1-hexyn-3-ol, and 1 part by weight of finely divided copper phthalocyanine. The mould releasability, Asker C hardness, and compression set were measured as in Example 2 on silicone gels produced by the cure of this silicone gel composition. The results are reported in Table 2.

TABLE 2

| | Example 2 | Comp. Ex. 3 | Comp. Ex. 4 |
|---|---|---|---|
| Asker C | 11 | 11 | 11 |
| hardness | | | |
| Mould releasa- | no sticking to the | strong sticking to | strong sticking to |
| bility | mould, could be | the mould, the | the mould, the |
| | easily peeled out | silicone gel was | silicone gel was |
| | | torn | torn |
| compression | 22% | 83% | 71% |
| set | | | |

The mouldable silicone gel composition in accordance with the present invention is distinguished by its capacity for moulding into a low compression set silicone gel that exhibits an excellent mould releasability.

What is claimed is:

1. A mouldable silicone gel composition comprising:
A. 100 parts by weight of an organopolysiloxane having at least two alkenyl groups in each molecule,
B. an organopolysiloxane having at least two silicon-bonded hydrogen atoms in each molecule, in an amount such that the molar ratio of silicon bonded hydrogen atoms in component B to alkenyl groups in component A is from 0.5:1 to 10:1,
C. greater than 200 parts to 500 parts by weight of an organopolysiloxane which is free of alkenyl groups and free of silicon bonded hydrogen, and
D. a platinum group catalyst, in an amount sufficient to effect the cure of the composition.

2. The mouldable silicone gel composition in accordance with claim 1, which additionally comprises a component E, a finely divided silica, in an amount of from 1 to 100 parts by weight per 100 parts by weight of component A.

3. The mouldable silicone gel composition in accordance with claim 1 wherein component A is selected from at least one of the group consisting of:
i. dimethylalkenylsiloxy-endblocked dimethylpolysiloxanes;
ii. dimethylalkenylsiloxy-endblocked dimethylsiloxane-methylalkenylsiloxane copolymers;
iii. trimethylsiloxy-endblocked dimethylsiloxane-methylalkenylsiloxane copolymers;
iv. organopolysiloxanes comprising the (CH₃)₃SiO_{1/2}, (CH₃)₂(alkenyl)SiO_{1/2}, and SiO_{4/2} siloxane units;
v. organopolysiloxanes as defined in i to iv above wherein a proportion of the methyl groups are replaced by an organic group selected from the group of ethyl, propyl, phenyl tolyl and/or 3,3,3-trifluoropropyl; wherein the alkenyl group is selected from the group of vinyl, allyl, propenyl, butenyl, pentenyl, and hexenyl.

4. The mouldable silicone gel composition in accordance with claim 1 wherein component B is selected from at least one of the group consisting of:
i dimethylhydrogensiloxy-endblocked dimethylpolysiloxanes;
ii. trimethylsiloxy-endblocked methylhydrogenpolysiloxanes;
iii. trimethylsiloxy-endblocked dimethylsiloxane-methylhydrogensiloxane copolymers;
iv. cyclic methylhydrogenpolysiloxanes;
v. organopolysiloxanes comprising the (CH₃)₂HSiO_{1/2} and SiO_{4/2} siloxane units; and
vi. organopolysiloxanes as defined in i to v above wherein a proportion of the methyl groups are replaced by an organic group selected from the group of ethyl, propyl, phenyl tolyl and/or 3,3,3-trifluoropropyl.

5. The mouldable silicone gel composition in accordance with claim 1 wherein component C is selected from the group consisting of:
a trimethylsiloxy-endblocked dimethylpolysiloxane,
a trimethylsiloxy-endblocked dimethylsiloxane-methylphenylsiloxane copolymer,
a trimethylsiloxy-endblocked dimethylsiloxane-diphenylsiloxane copolymer,
a dimethylphenylsiloxy-endblocked dimethylpolysiloxane and
a dimethylphenylsiloxy-endblocked dimethylsiloxane-methylphenylsiloxane copolymer

6. A method of producing a silicone gel composition in accordance with claim 2 comprising the steps:
i. intermixing components A and E, and optionally a proportion of component C with heating to form a silicone gel base; and then
ii. adding components B and D and all or any remaining part of component C to the silicone gel base made in step i.

7. A moulded silicone gel made from a composition in accordance with claim 1.

8. A moulded silicone gel in accordance with claim 7 having an Asker C hardness of from 1 to 30°.
